(19) United States
(12) Patent Application Publication
(10) Pub. No.: US 2015/0363955 A1
(43) Pub. Date: Dec. 17, 2015

(54) DISPLAY DEVICE, IMAGE DISPLAY SYSTEM AND CONTROL PROGRAM FOR IMAGE DISPLAY SYSTEM

(71) Applicant: GE MEDICAL SYSTEMS GLOBAL TECHNOLOGY COMPANY, LLC, Waukesha, WI (US)

(72) Inventors: Tatsuo Kawanaka, Tokyo (JP); Takeyoshi Uenishi, Tokyo (JP)

(21) Appl. No.: 14/761,263

(22) PCT Filed: Jan. 14, 2014
(86) PCT No.: PCT/US2014/011408

§ 371 Date: Jul. 15, 2015

(30) Foreign Application Priority Data
Jan. 15, 2013 (JP) 2013-004208

(51) Int. Cl. G06T 11/60

(52) U.S. Cl. CPC G06T 11/60

(57) ABSTRACT

An image display system capable of readily grasping whether or not there are images which are not displayed on a display unit with no need of moving a screen is provided. The system includes a list preparation unit for preparing a list that simple images which are based on medical data are arranged in a matrix, and a display screen on which the aforementioned list is partially displayed, the display screen on which an indicator indicating presence and/or absence of the simple images which are not displayed on the display screen, and indicating presence and/or absence of the aforementioned simple images on at least any one of the upper side, the lower side, the right side and the left side of a displayed part of the aforementioned list is displayed. The indicator includes a number of simple images which are not displayed on the aforementioned display screen.

### TECHNICAL FIELD

The present invention relates to a display device on which a list of images which are based on medical data of a patient is displayed, an image display system and a control program for image display system.

### BACKGROUND ART

A display device which is connected with a server over a network and displays images which are based on medical data stored in this server is described, for example, in Patent Document 1.

The medical data which is stored in the aforementioned server is data on medical use images such as, for example, X-ray CT images which have been imaged by an X-ray CT (Computed Tomography) device, MRI images which have been imaged by an MRI (Magnetic Resonance Imaging) device and so forth. Other than the above, the one that a paper document which is used in a hospital such as a patient referral document or the like has been scanned and data-organized and others are also included in the aforementioned medical data.

Prior Art Document: Japanese Patent Application Laid-Open No. 2010-182018

### SUMMARY OF THE INVENTION

### Problems to be Solved by the Invention

Incidentally, there are cases when enormous medical use images and documents are prepared and data thereof is saved for a patient who visits in hospital. In a case where a diagnosis is to be made, it is necessary for an operator to find out related medical use images and documents from within them in accordance with object. Thus, the inventors of the present patent application propose a display device for displaying a list that medical use images and documents are arranged in a matrix so as to make it possible to effectively find out required medical use images and documents. In this list, thumbnails of medical use images and documents of even date are arranged, for example, in a row direction (a lateral direction) and thumbnails of the same kind of documents are arranged in a column direction (a longitudinal direction).

Incidentally, when the number of medical use images and documents is large, there are cases when all the thumbnails cannot be displayed on one screen. In this case, the operator will move the screen to confirm necessary thumbnails.

Accordingly, it was necessary for the operator to move the screen, in order to confirm whether thumbnails are present in an area which is not displayed on the screen, and it was troublesome.

### Means for Solving the Problem

The invention of one viewpoint which has been made in order to solve the aforementioned problem is a display device and an image display system characterized by including a display unit on which a list that images which are based on medical data are arranged in a matrix is partially displayed, the display unit on which an indicator indicating presence/absence of images which are nor displayed on the aforementioned display unit, and indicating presence/absence of the aforementioned images on at least one of the upper side, the lower side, the right side and the left side of a displayed part of the aforementioned list in the images configuring the aforementioned list.

### Advantage of the Invention

According to the invention of the aforementioned viewpoint, since the indicator indicating presence/absence of the images which are not displayed on the aforementioned display unit, and indicating presence/absence of the aforementioned images on at least one of the upper side, the lower side, the right side and the left side of the displayed part of the aforementioned list is displayed, whether there exist the images which are not displayed on the aforementioned display unit can be grasped without moving the screen.

### BRIEF DESCRIPTION OF THE DRAWINGS

FIG. 1 is a block diagram of an image display system pertaining to an embodiment.

FIG. 2 is a diagram showing a display screen of a display unit on which a list is displayed.

FIG. 3 is flowchart showing an operation of the image display system.

FIG. 4 is a diagram explaining counting of simple images by a counting unit.

FIG. 5 is a diagram explaining a dragging operation.

FIG. 6 is a diagram showing the display screen of the display unit on which the list is displayed and the diagram showing a state that a displayed part of the list has been moved downward from the state shown in FIG. 2 and FIG. 5.

FIG. 7 is diagram showing the display screen of the display unit on which the list is displayed and the diagram showing a state that the displayed part of the list has been moved further in a downward direction from the state shown in FIG. 6.

FIG. 8 is a diagram showing the display screen of the display unit on which the list is displayed.

FIG. 9 is a diagram showing the display screen of the display unit on which the list is displayed and the diagram showing a state that the displayed past of the list has been moved in a rightward direction from the state shown in FIG. 8.

FIG. 10 is a diagram showing the display screen of the display unit on which the list displayed and the diagram showing a state that the displayed part of the list has been moved further in the rightward direction from the state shown in FIG. 9.

FIG. 11 is a diagram explaining a numerical value displaying method.

FIG. 12 is a diagram showing a state that a display area has been moved downward from the state shown in FIG. 11.

FIG. 13 is a diagram showing a state that the display area has been moved rightward from die state shown in FIG. 11.

FIG. 14 is a diagram showing a state that the display area has been moved downward from the state shown in FIG. 11 in a first modified example.

FIG. 15 is a diagram showing a state that the display area has been moved rightward from the state shown in FIG. 11 in the first modified example.

FIG. 16 is a diagram showing a display screen of a display unit when an indicator has been clicked in a second modified example.

FIG. 17 is a diagram explaining movement of the display area when the indicator has been clicked.

FIG. 18 is a diagram explaining movement of the display area when the indicator has been clicked and the diagram showing a state that the display area has been moved from the state shown in FIG. 17.

FIG. 19 is a diagram explaining movement of the display area when the indicator has been clicked and the diagram showing a state that the display area has been moved from the state shown in FIG. 17.

FIG. 20 is a diagram showing a display screen of a display unit on which a list is displayed in a third modified example.

FIG. 21 is a diagram explaining a numerical value displaying method in the third modified example.

FIG. 22 is a diagram explaining the numerical value displaying method in the third modified example.

FIG. 23 is a diagram explaining the numerical value displaying method in the third modified example.

FIG. 24 is a diagram showing a display screen on which an indicator is displayed in a fourth modified example.

FIG. 25 is a diagram showing the display screen on which another example of the indicator is displayed.

FIG. 26 is a block diagram showing another example of the image display system pertaining to the embodiment.

### EMBODIMENTS OF THE INVENTION

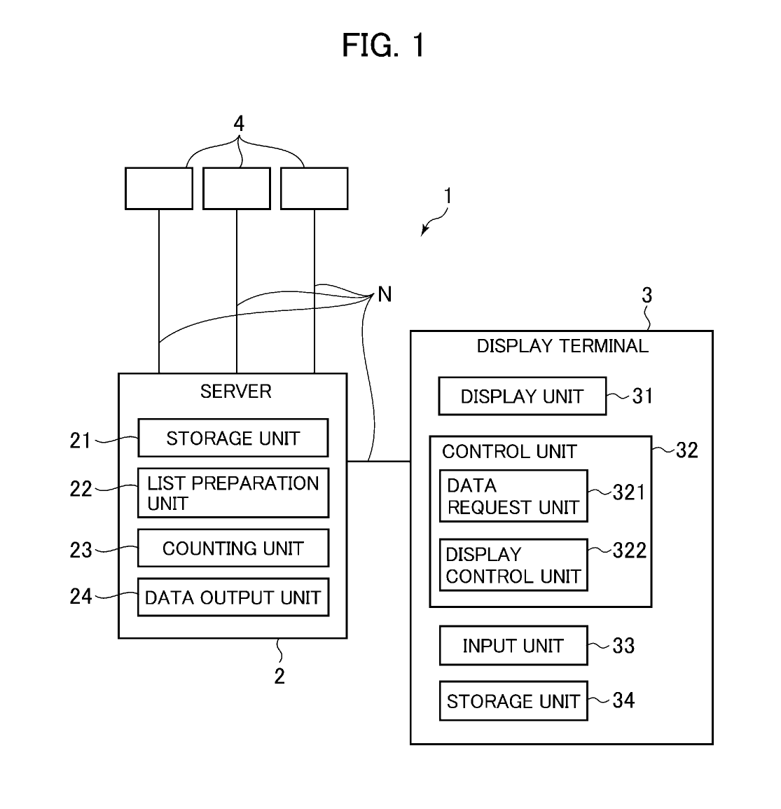

In the following, embodiments of the present invention will be described in detail on the basis of the drawings. An image display system 1 shown in FIG. 1 has a server 2 and a display terminal 3 which are connected together over a network N. A plurality of department systems 4 are connected to the aforementioned server 2 over the network N. The aforementioned image display system 1 is one example of an embodiment of an image display system pertaining to the present invention, hi addition, the aforementioned display terminal 3 is an example of an embodiment of a display device pertaining to the present invention.

The aforementioned server 2 has a storage unit 21, a list preparation unit 22, a counting unit 23 and a data output unit 24, The aforementioned storage unit 21 is, for example, an HDD (Hard Disk Drive) or the like. Medical data or the like which has been input from each of the aforementioned department systems 4 into the aforementioned server 2 over the aforementioned network N is stored in the aforementioned storage unit 21. The aforementioned server 21 is one example of an embodiment of a server in the present invention, and the aforementioned storage unit 21 is one example of an embodiment of a storage unit in the present invention.

The medical data which is stored in the aforementioned storage unit 21 is data on a patient which is prepared by a health care providing facility, a test facility that in vitro medical tests are made or the like, and is medical use image data, document data, numerical value data and so forth. The medical use image data is data which has been acquired by a modality or the like of the aforementioned department system 4, and is image data such as, tor example, X-ray CT images, MRI images, ultrasound images and so forth. The document data is data on such as, for example, medical image interpretation reports, patient referral documents, consent forms such as a surgery consent form, a test consent form and so forth, medical questionnaires, written applications, test results and so forth. In the document data, PDF (Portable Document Format) data or the like which has been data-organized by scanning paper documents is also included. In addition, the numerical value data is data on numerical values pertaining to a patient, for example, data on numerical values indicating a result of a test such as, for example, a blood test or the like.

In the aforementioned medical data, data on progress note of bio-information of the patient such as an electrocardiogram or the like and on other records relating to the patient are also included, in addition to the aforementioned medical use image data, the aforementioned document data and the aforementioned numerical value data which have been listed hereinabove.

The medical use data includes metadata in addition to the data body. The metadata is constituted of incidental information of a plurality of attributes such as, for example, the name of the patient, a date, a document kind, document classification, an ordering provider department and so forth. Here, the term “incidental information” means the definite name, date, document kind, document classification and ordering provider department, and the attributes mean attributes of these pieces of incidental information. For example, the incidental information of the attribute called “Document Kind” is “CP”, “MRI” and so forth. The incidental information of the attribute called “Ordering Provider Department” is “Radiography Department”, “Cardiology Department” and so forth. The metadata is a concept which includes the attribute information (for example, the information called “Document Kind”) and the concrete information on that attribute (that is, the incidental information, for example, the information called “CT”).

The one which is automatically imparted in the aforementioned department system 4 such as, for example, the modality or the like of the X-ray CT device or the like, and the one which is imparted by inputting from the operator are included in the aforementioned metadata.

The date in the metadata is, for example, a medical data preparation day. Not only the day but also a year, a time and so forth may be included in the date in the metadata. For medical image data, an imaging day may be the preparation day. In addition, for document data, a day that a document has been prepared may be the preparation day or a day that the document has been scanned and data-organized may be the preparation day.

The document kind in the aforementioned metadata is information indicating the kind of medical data, for example, information indicting the kind of medical use images such as MRI (Magnetic Resonance Imaging) one, US (Ultrasound) ones and so forth and the kind of documents such as a hospitalization consent form, a hospitalization written application, a hospitalization questionnaire, a test consent form, a surgery consent form and so forth. In addition, the document classification in the metadata is information indicating the superordinate concept of the document kind such as, for example, the consent forms and so forth.

In addition, the ordering provider department in the aforementioned metadata is information indicating the department that the preparation of the medical data has been ordered such as, for example, the department of radiology, the department of cardiology and so forth.

The attributes in the aforementioned metadata may be determined in advance. In addition, even when they are determined in advance, the attributes may be made to be added and deleted.

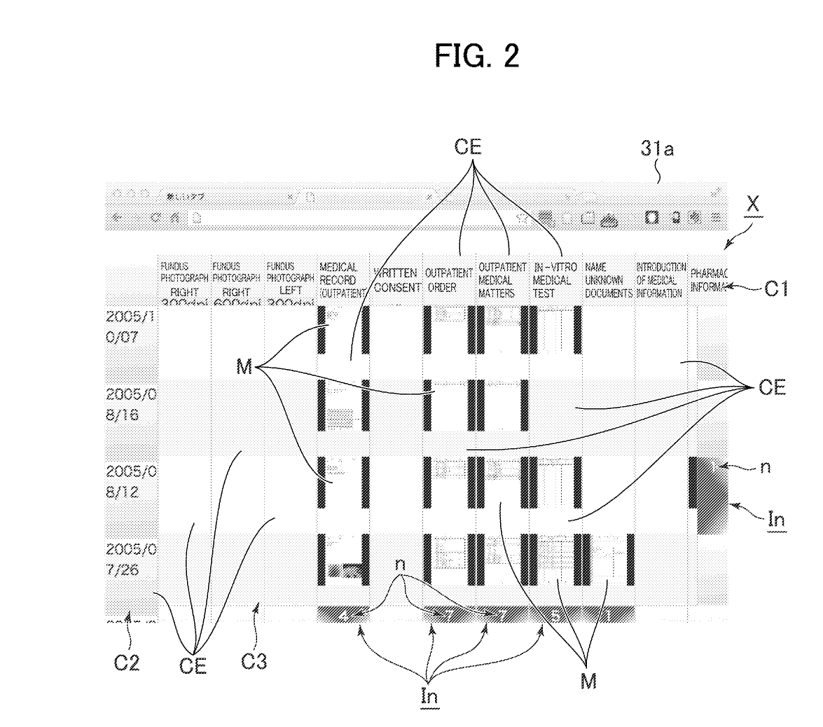

The aforementioned list preparation unit 22 prepares (a list preparation function) data for a list X of the simple images M of the same patient which is based on the medical data stored in the aforementioned storage unit 21. As described later, the aforementioned list X is displayed on the aforementioned display terminal 3 (see FIG. 2). The aforementioned list preparation unit 22 is one example of an embodiment of a list preparation unit in the present invention. In addition, the list preparation function is one example of an embodiment of a list preparation function in the present invention.

The aforementioned counting unit 23 counts the simple images M in the row direction and the column direction of the aforementioned list X to obtain numerical value data for making a numerical value n which indicates die number of single images M which are not displayed on the aforementioned display terminal 3 to be displayed. Details will be described later. The aforementioned counting unit 23 is one example of an embodiment of a counting unit in die present invention.

The aforementioned data output unit 24 outputs the data for the list X prepared by the aforementioned list preparation unit 22 to the aforementioned display terminal 3 in accordance with a request from the aforementioned display terminal 3.

Although in FIG. 1, the aforementioned list preparation unit 22, the aforementioned counting unit 23 and the aforementioned data output unit 24 are disposed in the same server as diat of the storage unit 21 diat the aforementioned medical data is stored, the aforementioned list preparation unit 22, the aforementioned counting unit 23 and the aforementioned data output unit 24 may be disposed in a server different from that of the aforementioned storage unit 21.

The aforementioned display terminal 3 is, for example, a mainframe personal computer. In addition, the aforementioned display terminal 3 may be a tablet-type computer. The aforementioned display terminal 3 has a display unit 31, a control unit 32, an input unit 33 and a storage unit 34.

The aforementioned display unit 31 is an LCD (Liquid Crystal Display), a CRT (Cathode Ray Tube) or die like. The aforementioned display unit 31 is one example of an embodiment of a display unit in the present invention.

The aforementioned control unit 32 has a data request unit 321 and a display control unit 322. The aforementioned data request unit 321 outputs a signal for requesting the medical data to the aforementioned server 2 on the basis of input from the operator in the aforementioned input unit 33.

As shown in FIG. 2, the aforementioned display control unit 322 makes the list X of the simple images M of the same patient which are based on the medical data stored in the aforementioned storage unit 21 to be displayed on a display screen 31a of the aforementioned display unit 31. The data for the aforementioned list X is prepared by the aforementioned list preparation unit 22. In FIG. 2, the list X displayed on the aforementioned display unit 31 is a part of the list X prepared by the aforementioned list preparation unit 22. The aforementioned display control unit 322 is one example of an embodiment of a display control unit in the present invention.

The aforementioned list X includes display columns C1 and C2 for the incidental information, and a display column C3 for the simple images. These display columns C1 and C2 for the incidental information and the display column C3 for the simple images are each configured by a plurality of cells CE. In the aforementioned list X, the display column C1 for the aforementioned incidental information is configured by the cells CE arrayed in the row direction (the lateral direction) and configuring the uppermost row. In addition, in the aforementioned list X, the display column C2 for the aforementioned incidental information is configured by the cells CE arrayed in the column direction (the longitudinal direction) and configuring the leftmost column.

The aforementioned display control unit 322 makes the incidental information of the same attribute to be displayed on the display column C1 for the aforementioned incidental information. In addition, the aforementioned display control part 322 makes the incidental information of the same attribute to be displayed also on the display column C2 for the aforementioned incidental information. Then, the incidental information of different attributes is displayed on the display column C1 for the aforementioned incidental information and the display column C2 for the aforementioned incidental information. In FIG. 2, the document kind is displayed on the display column C1 for the aforementioned incidental information and the date (the year, the month and the day) is displayed on the display column C2 for the aforementioned incidental information. The incidental information to be displayed on the display column C1 for the aforementioned incidental information is one example of an embodiment of incidental information of one attribute in the present invention. In addition, the incidental information to be displayed on the display column C2 for the aforementioned incidental information is one example of an embodiment of incidental information of another attribute in the present invention.

The attributes of the display columns C1 and C2 for the aforementioned incidental information may be made changeable by performing an inputting operation by the operator using the aforementioned input unit 33.

In addition, the simple images M based on the medical data are displayed on the display column C3 for the aforementioned simple images. The simple images M are thumbnail images and so forth. The data of the aforementioned simple images M is prepared by the list preparation unit 22 of the aforementioned server 2. The aforementioned simple image M is one example of an embodiment of an image in the present invention.

Here, preparation of the aforementioned simple image M will be described. The aforementioned simple image M is prepared by the aforementioned list preparation unit 22. In a case where the simple image M displayed on the display column C3 for the aforementioned simple images is a medical use image which is based on the aforementioned medical use image data, one piece of medical use image data which has been selected from within a plurality of pieces of medical use image data generated in one test. Within the plurality of pieces of medical use image data generated in one test, the first data or intermediate data may be automatically selected. Then, the selected one piece of medical use image data is converted into a size which is appropriate to be displayed on the list X. This size is a size of an extent that it can be arranged on the display screen 31a while maintaining perspicuity (for example, 64×64 pixels, 96×96 pixels or the like). The simple image M which is based on the medical use image data so converted as mentioned above is displayed in the cell CE configuring the display column C3 for the aforementioned simple images.

In addition, in a case where the aforementioned simple image M is an image which is based on the document data, if the document data is the plurality of pieces of document data, for example, first document data will be selected and the data so selected will be converted into an appropriate size in the same manner as the above. Then, the image data M which is based on the converted data is displayed on die display column C3 for the aforementioned simple images.

In addition, in a case where the medical data which is displayed as the simple image M is numerical value data, an image indicating die contents of this numerical value data is prepared and this image is displayed as the simple image M. For example, the image indicating the contents of the numerical value data is an image consisting of characters indicating the contents of the numerical value data. To take an example, with regard to numerical value data for a blood test, an image consisting of die characters of “Blood Test” is displayed as the aforementioned simple image M.

The aforementioned display control unit 322 may display an enlarged simple image M by clicking the simple image M displayed on the display column C3 for the aforementioned simple images by the operator using the aforementioned input unit 33.

The incidental information in the longitudinal direction (the column direction) of the display column C3 for the aforementioned simple images is displayed in die cell CE configuring the display column C1 for the aforementioned incidental information. In addition, the incidental information in the lateral direction (the row direction) of the display column C3 for the aforementioned simple images is displayed in the cell CE configuring the display column C2 for the aforementioned incidental information. In the display column C3 for the aforementioned simple images, the simple images M are arranged in a matrix (Matrix). In the display column C3 for the aforementioned simple images, the simple images M having the incidental information displayed in the cells CE configuring the display column C1 for the aforementioned incidental information are arranged in the column direction, and the simple images M having the incidental information displayed in the cells CE configuring the display column C2 for the aforementioned incidental information are arranged in the row direction. In die display column C3 for the aforementioned simple images, the aforementioned simple images M are arranged at positions specified from two pieces of incidental information on the display column C1 for the aforementioned incidental information and the display column C2 for the aforementioned incidental information.

Specifically, in FIG. 2, the list X that the simple images M of each document kind are arrayed in the column direction and the simple images M of each date are arrayed in the row direction is displayed. Explaining by taking one example, in the display column C3 for the simple images, the aforementioned display control unit 322 makes the simple images M (the thumbnail images indicating scanned images of an in-vitro medical test) which are based on the medical data having information indicating the in-vitro medical test as the incidental information to be displayed in the column of the cells CE displayed as “In-vitro Medical Test” in the display column C1 for the aforementioned incidental information, hi addition, in the display column C3 for the simple images, the aforementioned display control unit 322 makes the simple images M based on the medical data having the date information of Oct. 7, 2005 as the incidental information to be displayed, for example, in the row of the cells CE displayed as “2005/10/07” in the display column C2 for the aforementioned incidental information. As described above, the aforementioned display control unit 322 makes the aforementioned list X that the aforementioned simple images M are arranged in the row direction for every incidental information of one attribute and are arranged in the column direction for every incidental information of another attribute to be displayed.

In a case where the attributes of the display columns C1 and C2 for the aforementioned incidental information have been changed, the aforementioned display control unit 322 rearranges the aforementioned simple images M accordingly.

The operator performs a dragging operation by foe aforementioned input unit 33, thereby making it possible to move a part (a displayed part of the list X) which is displayed on the aforementioned display screen 31a in the aforementioned list X in the longitudinal direction, the lateral direction and an oblique direction. In a case where the aforementioned display unit 31 is a touch panel type display, the operator can move the displayed part of the aforementioned list X in the longitudinal direction, the lateral direction and the oblique direction by performing the dragging operation or a flicking operation with fingers. When the inputting operation such as the aforementioned dragging operation, the flicking operation or the like is performed by the aforementioned input unit 33, the aforementioned display control unit 322 makes the displayed part of the aforementioned list X move in the direction according to that inputting operation. Since the operator can move the displayed part of the aforementioned list X in a desired direction as mentioned above, the operability is favorable.

In addition, the aforementioned display control unit 322 makes an indicator (Indicator) In to be displayed on the list X displayed on the aforementioned display unit 31. This indicator In indicates presence of the simple images M which are not displayed on the aforementioned display unit 31 in the simple images M configuring the list X which has been prepared by the aforementioned list preparation unit 22, and indicates presence/absence of the aforementioned simple images M at least on either the lower side or the right side of the displayed part of the aforementioned list X. The aforementioned indicator In includes a numerical value n indicating the number of simple images M which are not displayed on the aforementioned display unit 31. Details will be described later. The aforementioned indicator In is one example of an embodiment of an indicator in the present invention. A display control function for the aforementioned indicator In by the display control unit 322 is one example of an embodiment of a display control function in the present invention.

The aforementioned input unit 33 is configured by a keyboard, a mouse and so forth. The aforementioned input unit 33 is one example of an embodiment of an input unit in the present invention.

The aforementioned storage unit 34 is, for example, an HDD or a semiconductor memory such as a RAM (Random Access memory), a ROM (Read Only Memory) or the like.

The aforementioned department system 4 is a department system in a hospital such as, for example, a radiology information system (RIS) including the modalities of the X-ray CT device, the MRI device and so forth, a laboratory testing system or the like.

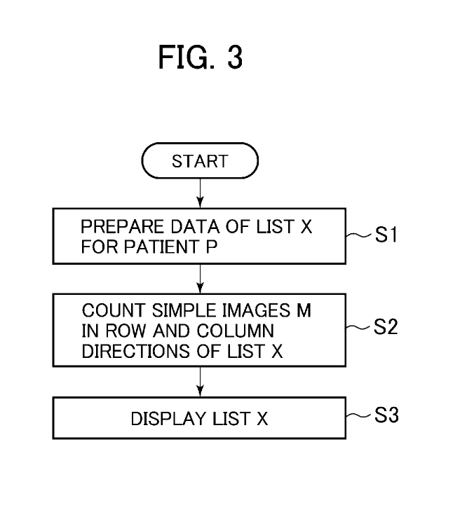

Next, the operation of the image display system 1 in this example will be explained on the basis of a flowchart in FIG. 3, First, in step S1, the aforementioned list preparation unit 22 prepares the data for the list X. Specifically, first the operator inputs specific information on a patient P such as his name, his ID and so forth by the input unit 33 of the aforementioned display terminal 3. Next, the aforementioned data request unit 321 makes a request for the data for the list X relating to the aforementioned patient P whose specific information has been input to the aforementioned server 2. In this request, the specific information of the patient P is included.

When the request for the data for the aforementioned list X is made from the aforementioned data request unit 321, the list preparation unit 22 of the aforementioned server 2 prepares the data for the list X. Describing in detail, first, the aforementioned list preparation unit 22 specifies the medical data on the patient P which is stored in the aforementioned storage unit 21 on the basis of the specific information of the patient P which has been input from the aforementioned data request unit 321. Then, the aforementioned list preparation unit 22 prepares the data for the list X consisting of the simple images M about the aforementioned patient P on the basis of the specified medical data on the patient P.

Next, in step S2, the aforementioned counting unit 23 counts the simple images M in the row direction and the column direction of the aforementioned list X to obtain the numerical value data for displaying the numerical value n configuring the aforementioned indicator In. The aforementioned counting unit 23 obtains the aforementioned numerical value data for the aforementioned every cell CE. The aforementioned counting unit 23 obtains the aforementioned numerical value data in the row direction and the aforementioned numerical value data in the column direction with regard to the aforementioned each cell CE.

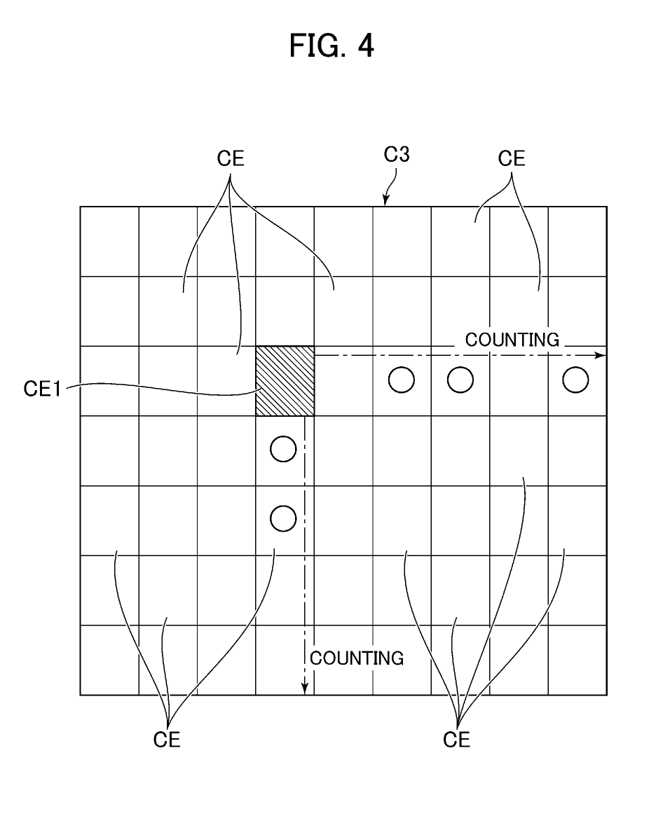

Specifically explaining, in FIG. 4, the cells CE on the display column C3 for the aforementioned simple images are shown in the list X prepared by the aforementioned list preparation unit 22. Here, an example of obtaining the aforementioned numerical value data for a shaded cell CE1 will be described.

A circle shown in the cell CE indicates that the simple image M is present. The aforementioned counting unit 23 counts the number of the simple images M which are present on the right side of the cell CE1 in the row that, the aforementioned cell CE1 belongs. In FIG. 4, the number of the simple images M which are present on the right side of the aforementioned cell CE1 is “3”. Thus, “3” is obtained as the numerical value data in the row direction with regard to the aforementioned cell CE1. The numerical value data in the row direction is stored in the aforementioned storage unit 21.

In addition, die aforementioned counting unit 23 counts the number of the simple images M which are present under die aforementioned cell CE1 in the column that the aforementioned cell CE1 belongs. In FIG. 4, the number of the simple images M which are present under the aforementioned cell CE1 is “2”. Thus, “2” is obtained as the numerical value data in the column direction with regard to the aforementioned cell CE1. This numerical value data in the column direction is also stored in the aforementioned storage unit 21.

The aforementioned counting unit 23 performs the above-mentioned counting with regard to all the cells CE to obtain the numerical value data in the row direction and the numerical value data in the column direction. Then, the numerical value data in the row direction and the numerical valued data in the column direction are stored in the aforementioned storage part 21 with regard to each cell CE.

The numerical value data in the row direction to be stored with regard to the aforementioned each cell CE is data on a numerical value indicating how many simple images M are present on the right side of that cell in the row that cell CE belongs. In addition, the numerical value data in the column direction to be stored with regard to the aforementioned each cell CE is data on a numerical value indicating how many simple images M are present under that cell CE in the column that that cell CE belongs.

Next, in step S3, the aforementioned data output unit 24 outputs the data for the aforementioned list X prepared in the aforementioned step S1 and the aforementioned numerical data obtained in the aforementioned step S2 to the aforementioned display terminal 3. Then, die aforementioned display control unit 322 makes the list X to be displayed on the aforementioned display unit 31 on the basis of the data for the aforementioned list X and the aforementioned numerical value data. A part of the list X which has been prepared by the aforementioned list preparation unit 22 is displayed on this display unit 31. The aforementioned display control unit 322 makes the aforementioned indicators In to be displayed on a right end and a lower end of the display column C3 for the simples images on the aforementioned list X.

The aforementioned indicators In are displayed per row and per column on the basis of the aforementioned numerical value data. The aforementioned indicator In which has been displayed on the right end of the display column C3 for the aforementioned simple images indicates that simple images M which are not displayed are present on the right side of the cell CE which is displayed in that row. In addition, the aforementioned indicator In which has been displayed on the lower end of the display column C for the aforementioned simple images indicates that simple images M which are not displayed are present on the lower side of the cell CE which is displayed in that column. Thus, in a row and a column that the aforementioned indictors In are not displayed, the simple images M are not present on the right side and the lower side of the cell CE which is being displayed.

The aforementioned display control unit 322 makes the numerical value n indicating the number of simple images M which are not displayed on the aforementioned display screen 31a to be displayed as a part of the aforementioned indicator In. The aforementioned numerical value n which has been displayed on the right end of the display column C3 for the aforementioned simple images indicates how many simple images M which are not displayed are present on the right side of the cell CE which is being displayed in that row. In addition, the aforementioned numerical value n which has been displayed on the lower end of the display column C3 for the aforementioned simple images indicates how many simple images M which are not displayed are present on the lower side of the cell CE which is being displayed in that column.

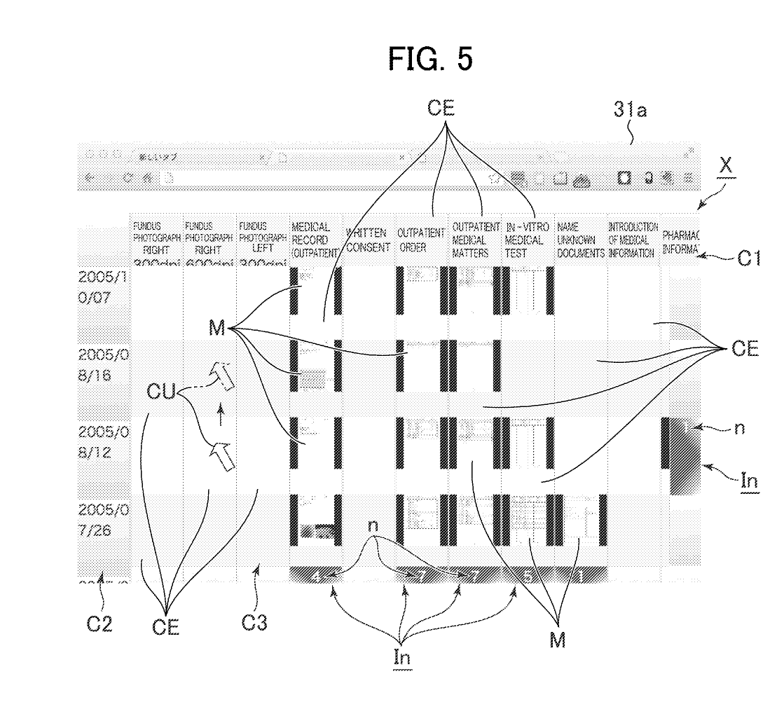

The operator can move the displayed part of the aforementioned list X by performing the dragging operation by placing a cursor CU on the display column C3 for the aforementioned simple images as shown in FIG. 5. By this dragging operation, he can move the displayed part of the aforementioned list X in any of the longitudinal direction, the lateral direction and the oblique direction.

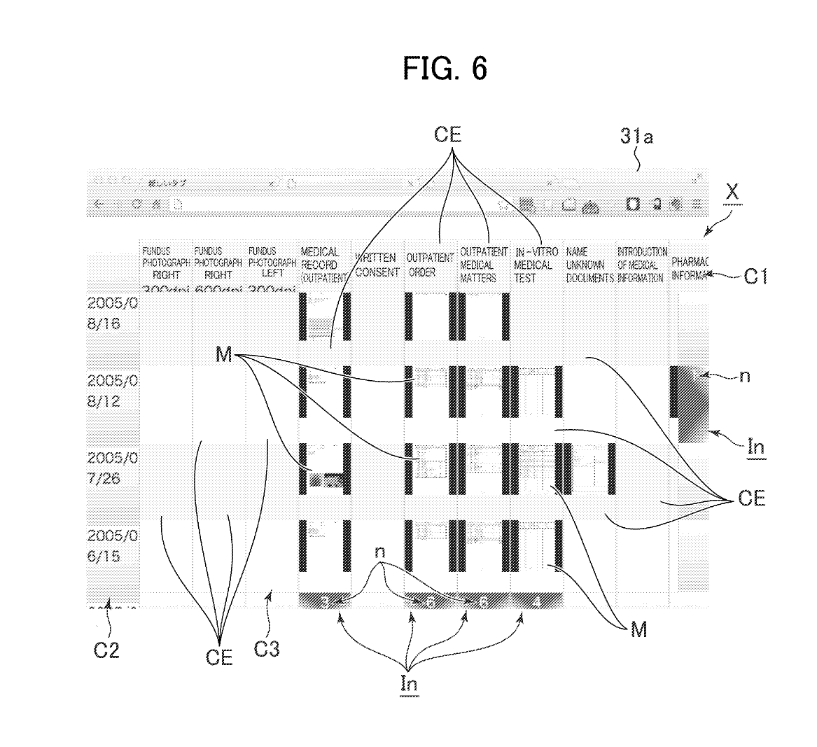

The aforementioned display control unit 322 changes the numerical value n of the aforementioned indicator In when the number of the simple images M which are not displayed on the aforementioned display screen 31a is changed with movement of the displayed part of the aforementioned list X. For example, when the displayed part of the aforementioned list X is moved in a downward direction from the state shown in FIG. 2 and FIG. 5 and the number of the simple images M which are not displayed on the aforementioned display screen 31a is reduced, the aforementioned numerical value n displayed on the lower end of the display column C3 for the aforementioned simple images becomes small as shown in FIG. 6. The operator can grasp how many simple images M which are not displayed on the aforementioned display screen 31a are still present on the lower side from the aforementioned numerical value n.

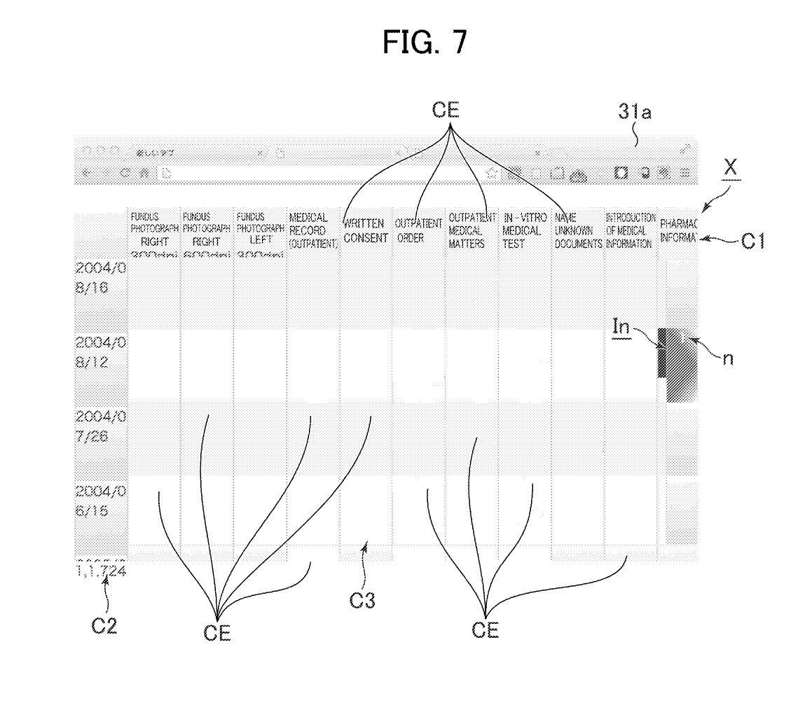

When the displayed part of the aforementioned list X is fiirther moved in the downward direction and the simple images M which are not displayed on the aforementioned display screen 31a come not to be present in all the columns, the aforementioned display control unit 322 does not display the aforementioned indicator In on the lower end of the display column C3 for the aforementioned simple images as shown in FIG. 7. The operator can grasp that the simple images M are not present under a currently displayed position and there is no need to move the displayed part of the list X further downward by ceasing to display the indicator In as mentioned above.

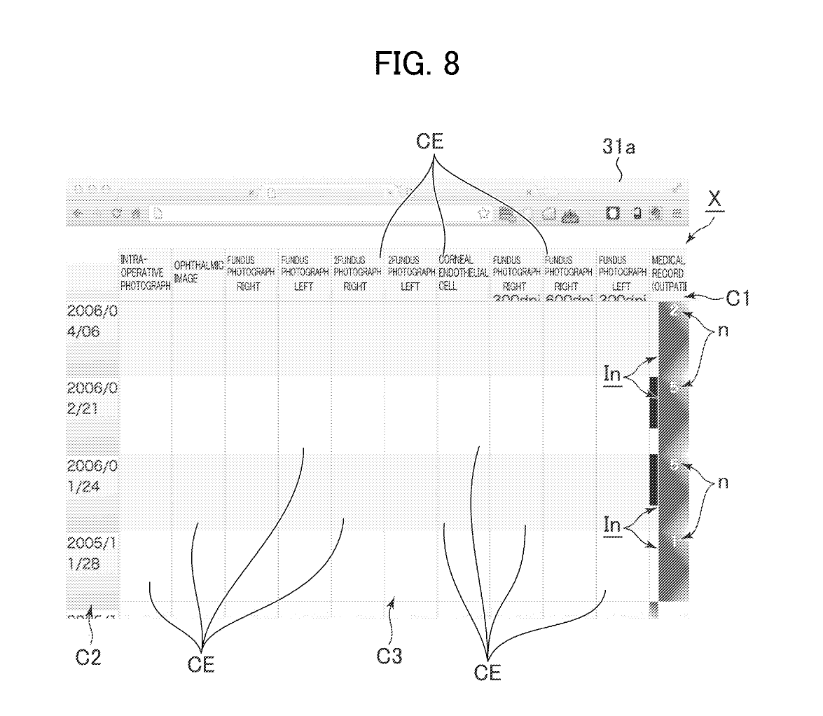

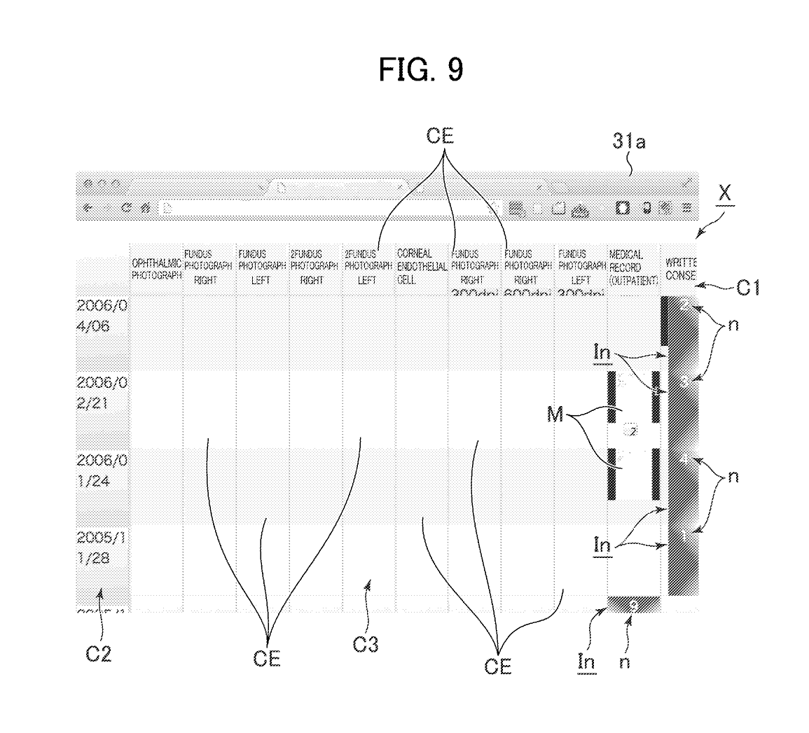

In addition, when the displayed pail of the list X displayed on the aforementioned display screen 31a is moved in the rightward direction from the state shown in FIG. 8 and the number of the simple images M which are not displayed on the aforementioned display screen 31a is reduced, the aforementioned numerical value n displayed on the right end of the display column C3 for the aforementioned simple images becomes smaller as shown in FIG. 9. The operator can grasp how many simple images M which are not displayed on the aforementioned display screen 31a are still present on the right side from the aforementioned numerical value n.

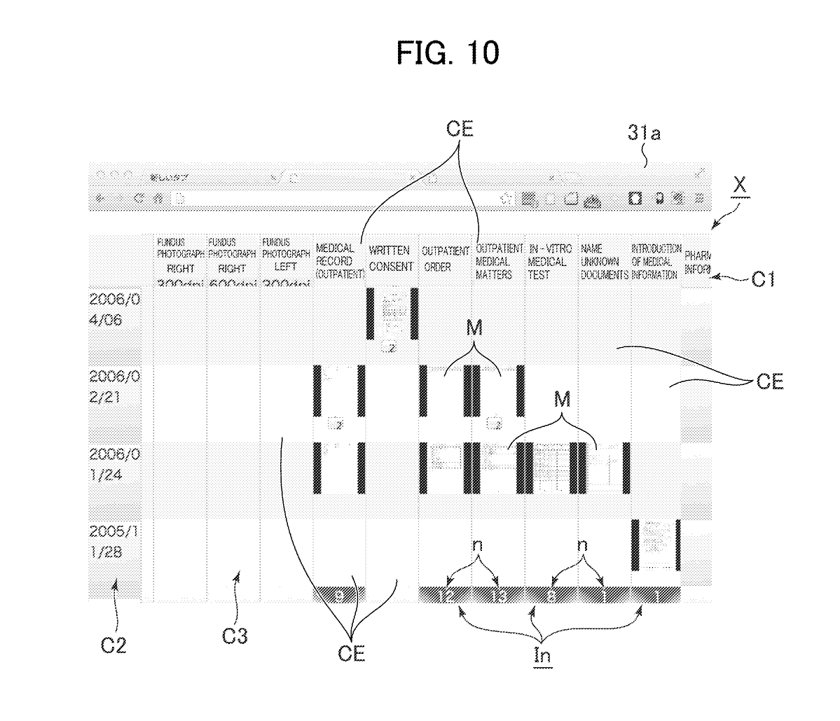

When the displayed part of the aforementioned list X is further moved in the rightward direction and the simple images M which are not displayed on the aforementioned display screen 31a come not to be present in all the rows, the aforementioned display control unit 322 does not display the aforementioned indicator In on the right end of the aforementioned simple image display column C3 as shown in FIG. 10. The operator can grasp that the simple images M are not present on the right side of the currently displayed position and there is no need to move the displayed part of the list X further downward by ceasing to display the indicator In as mentioned above.

A method of displaying the aforementioned numerical value n configuring the aforementioned indicator In will be described. The aforementioned display control unit 322 displays a numerical value of numerical value data which is stored for cells in the rightmost column and the lowermost row in the cells whose entire areas are being displayed on the aforementioned display screen 31a as the aforementioned numerical value n. However, in a case where the numerical value of the aforementioned numerical value data is zero, the aforementioned display control unit 322 makes the aforementioned indicator In not to be displayed.

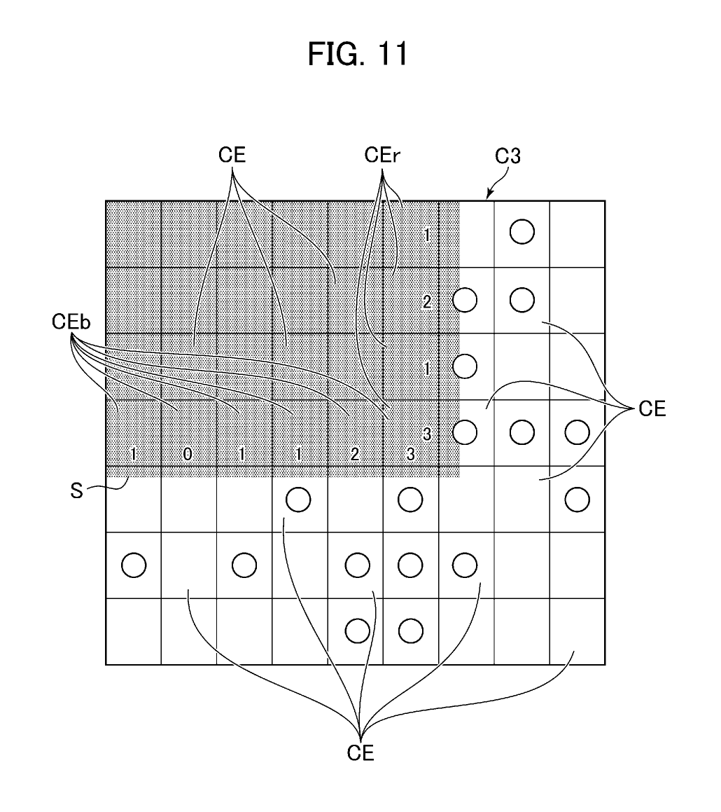

A description will be made specifically on the basis of FIG. 11. The display column C3 for the simple images in the list X is displayed in FIG. 11. However, it is simplified and only the cells CE are displayed. In FIG. 11, a dotted part to which a symbol S is assigned is a display area (the displayed part of the list X) which is displayed on the aforementioned display screen 31a. In addition, a circle indicates that the simple image M is present. However, regardless of presence of die simple image M in the cell CE within the aforementioned display area S, illustration of the circle is omitted.

In FIG. 11, in the cells CE which are included in the aforementioned display area S and all the areas of which are included in the aforementioned display area S, numerals indicated to cells CEr in the rightmost column and cells CEb in the lowermost row indicate the numerical value data in the row direction and the column direction which has been stored for the respective cells CE. For the aforementioned cells CEr, the numerical value data of “1”, “2”, “1” and “3” is stored in order from the top as the numerical value data in the row direction. In addition, for the aforementioned cells CEb, the numerical value data of “1”, “0”, “1”, “1”, “2” and “3” is stored in order from the left as the numerical value data in the column direction.

The aforementioned display control unit 322 makes the numerical value to be displayed on the right end of the display column C3 for the aforementioned simple images on the basis of the numerical value data which has been stored for the aforementioned cells CEr. Specifically, though not shown in the drawing in particular, “1”, “2”, “1” and “3” are displayed in order from the top as the aforementioned numerical value n on the right end of the display column C3 for the aforementioned simple images. In addition, the aforementioned display control unit 322 makes the numerical value n to be displayed on the lower end of the display column C3 for die aforementioned simple images on the basis of the numerical value data which has been stored for the aforementioned cells CEb. That is, though not shown in the drawing in particular, “1”, “1”, “1”, “2” and “3” are displayed as the numerical value n on the lower end of the display column C3 for die aforementioned simple images. However, the aforementioned indicator In is not displayed for the column (the second column from the leftmost side) that the numerical value of the numerical value data is “0”.

Incidentally, the positions of the numerals shown in FIG. 11 are different from the position of the aforementioned numerical value n which is to be displayed on the aforementioned display screen 31a.

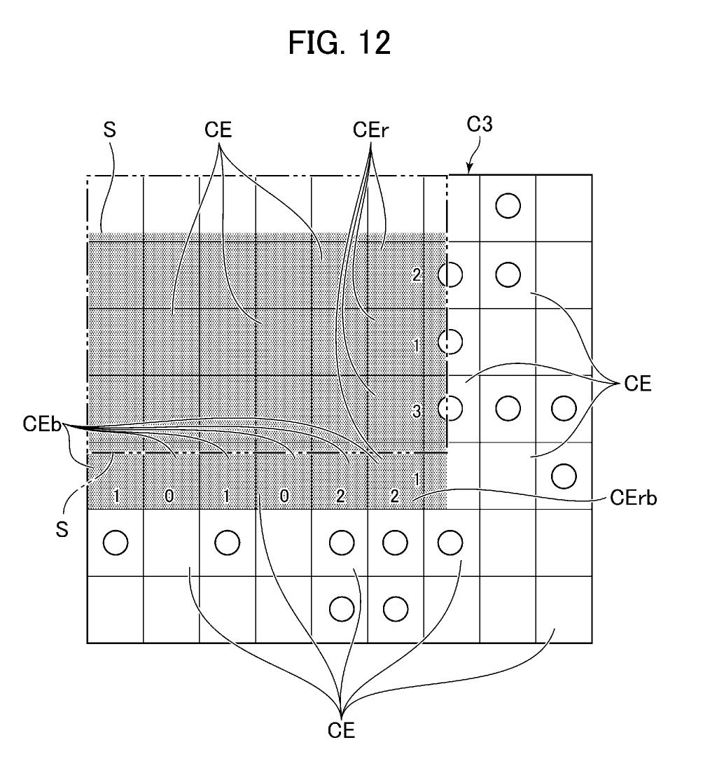

A case that the aforementioned display area S has moved downward from the position in FIG. 11 and has moved down to the position shown in FIG. 12 will be described. An area S′ surrounded with a two-dot chain line in FIG. 12 is the display area shown in FIG. 11.

The lower end of the display area S in FIG. 12 reaches the lower end of the cell configuring the row which is one under the row which has been the lowest in FIG. 11. When the lower end of the aforementioned display area S reaches this position, the numerical value n (“1”, “1”, “2” and “2”) which is based on die numerical value data stored for the cells CEb which have newly been in the lowest row in the aforementioned display area S is displayed on the lower end of the display column C3 for the aforementioned simple images. However, in the column (the fourth column from the leftmost side) of the cell CEb that the numerical value of the numerical value data has been newly reduced to “0”, display of the aforementioned indicator In disappears.

In addition, when the lower end of the aforementioned display area S reaches the position in FIG. 12, the indicator hi including die numerical value n (“1”) is newly displayed on the right end of the display column C3 for the aforementioned simple images on the basis of the numerical value data in the row direction which has been stored for a cell CErb which is in the rightmost column and has newly been in the lowermost row in the aforementioned display area S.

On the other hand, for the row (the uppermost row in FIG. 12) that all areas of the cells CE have come not to be displayed by downward movement of the aforementioned display area S, the aforementioned display control unit 322 makes the aforementioned indicator In not to be displayed.

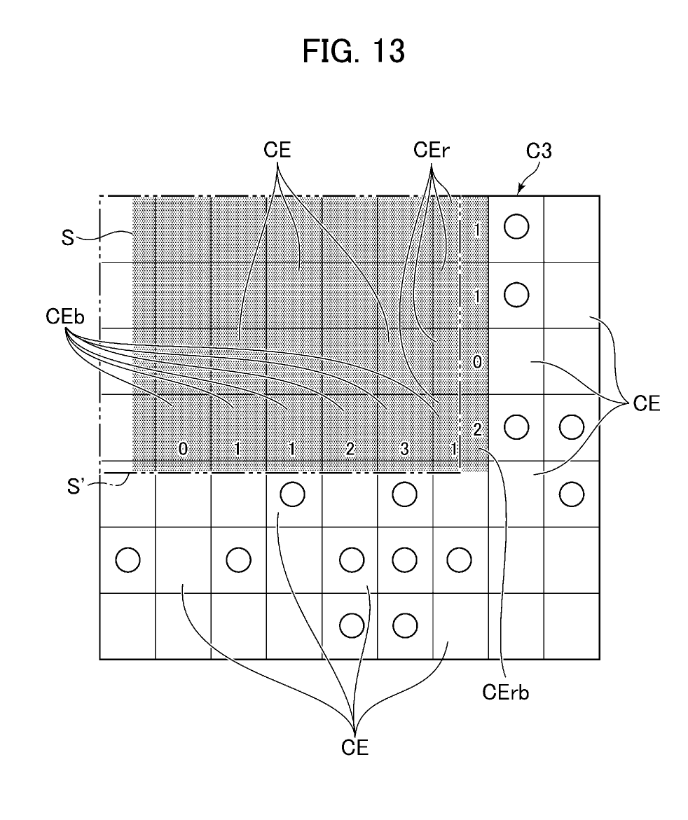

Next, a case that the aforementioned display area S has moved rightward from the position in FIG. 11 and moved to the position shown in FIG. 13 will be described. An area which is surrounded with a two-dot chain line and is designated by a symbol S′ in FIG. 13 is the display area shown in FIG. 11.

The right end of the display area S in FIG. 13 reaches the right end of the cell configuring the column which is one on the right side of the column which has been the rightmost one in FIG. 11. When the right end of the aforementioned display area S reaches this position, the numerical value n (“1”, “1” and “2”) which is based on the numerical value data which has been stored for the cells CEr which have newly been in the rightmost column in the aforementioned display area S is displayed on the right end of the display column C3 for the aforementioned simple images. However, in the row (the third column from the uppermost side) of the cell CEb that the numerical value of the numerical value data has newly been reduced to “0”, display of the aforementioned indicator In disappears.

In addition, when the right end of the aforementioned display area S reaches the position ill FIG. 13, the indicator In including the numerical value n (“1”) is newly displayed on the lower end of the display column C3 for the aforementioned simple images on the basis of the numerical value data in the column direction which has been stored for the cell CErb which is in the lowermost row and has newly been in the rightmost column in the aforementioned display area S.

On foe other hand, for the column (the leftmost column in FIG. 13) that all areas of the cells CE have come not to be displayed by rightward movement of the aforementioned display area S, the aforementioned display control unit 322 does not make the aforementioned indicator In display.

The list X is displayed by the processing in steps S1 to S3 which have been described hereinabove. In this list X, in a case where the attributes of the display columns C1 and C2 for the incidental information have been changed, the aforementioned processing in steps S1 to S3 is again performed. That is, the data for the list X is again prepared in the aforementioned step S1 and counting by the aforementioned counting unit 23 is again performed in the aforementioned step S2 in accordance with the changed attributes, by which the numerical value data is obtained. Then, the aforementioned list X is displayed on the basis of the data for the list X and the numerical value data which have been again obtained.

Next, modified examples will be described. First, a first modified example will be described. In this modified example, the numerical value of the numerical value data which is stored for a cell CE which is in the rightmost column and the lowermost row in the cells CE whose over ½ parts in a left/right direction or an up/down direction are displayed on the aforementioned display screen 31a is displayed as the aforementioned numerical value n. Thus, a timing that the aforementioned numerical value n changes when the displayed part of the aforementioned list X has moved becomes different from that in the above-mentioned embodiment.

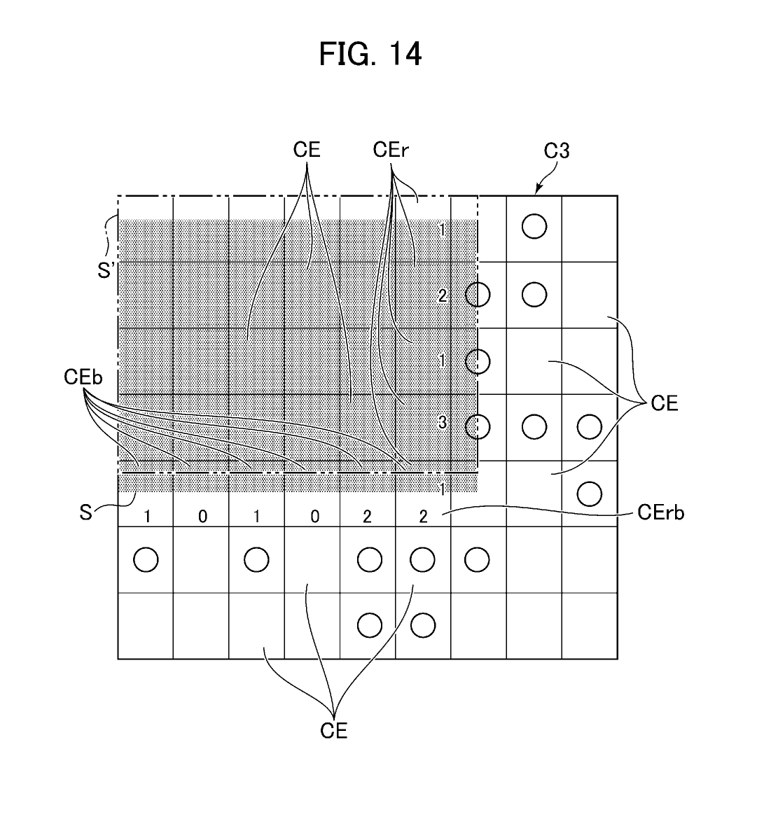

A description will be made specifically first on the basis of FIG. 14. FIG. 14 shows a state that the display area S has moved downward from the position in FIG. 11. It is assumed that the lower end of the aforementioned display area S is at a ½ position of the cell CEb in the up/down direction. In this example, this cell CEb is the cell in the lowermost row in the cells whose over ½ parts in the up/down direction are displayed on the aforementioned display screen 31a. The numerals “1”, “0”, “1”, “0”, “2” and “2” indicated in the aforementioned cells CEb are numerical values of the numerical value data in the column direction which has been stored for the aforementioned cells CEb.

In FIG. 14, the cells CEr in the column that the numerals “1”, “2”, “1”, “3” and “1” are indicated are the cells in the rightmost column in the cells whose over ½ parts in the left/right direction are displayed on the aforementioned display screen 31a. The aforementioned numerals “1”, “2”, “1”, “3” and “1” are numerical values of the numerical value data in the column direction which has been stored for the aforementioned cells CEr.

When the lower end of the aforementioned display area S reaches the position in FIG. 14, the aforementioned display control unit 322 makes the numerical value n (“1”, “1”, “2” and “2”) which is based on the numerical value data in the column direction which has been stored for the aforementioned cells CEb in FIG. 14 to be displayed on the lower end of the display column C3 for the aforementioned simple images. In addition, in the column (the fourth column from the leftmost side) of the cell CEb that the numerical value of the numerical value data has been newly reduced to “0”, display of the aforementioned indicator In disappears.

In addition, when the lower end of the aforementioned display area S reaches the position in FIG. 14 as described above, die indicator In including the numerical value n (“1”) is newly displayed on the right end of the display column C3 for the aforementioned simple images on the basis of the numerical value data in the row direction which has been stored for the cell CErb which is in the rightmost column and has newly been in the lowermost row in the aforementioned display area S.

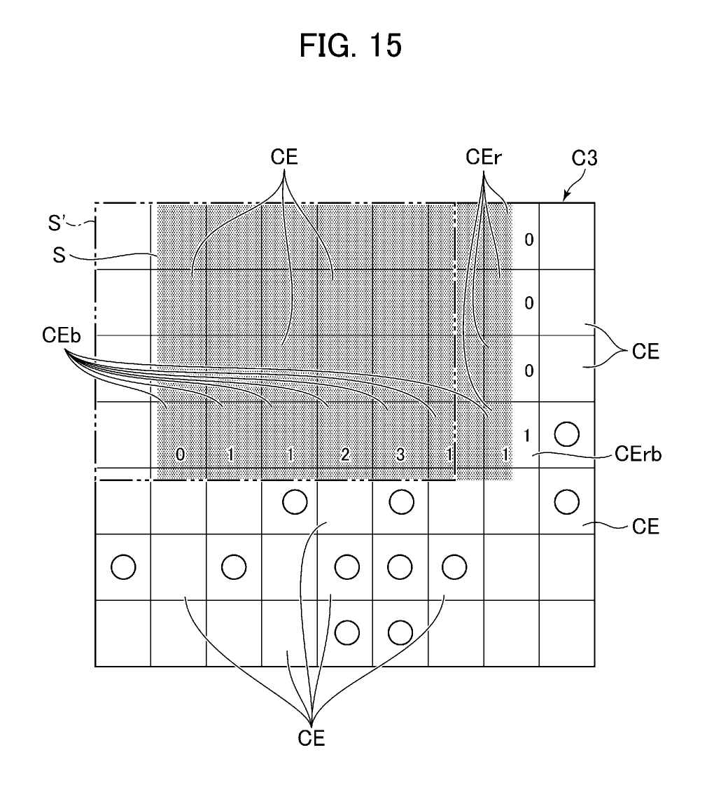

Next, a case where the display area of the aforementioned list X has moved rightward will be described on the basis of FIG. 15. FIG. 15 shows a state that the display area S has moved rightward from the position in FIG. 11, It is assumed that the right end of the aforementioned display area S is at a ½ position of the cell CEr in the left/right direction. In this example, this cell CEr is the cell in the rightmost column in the cells whose over ½ parts in the left/right direction are displayed. The numerals “0”, “0”, “0”, and “1” indicated in the aforementioned cells CEr are numerical values of the numerical value data in the row direction which has been stored for the aforementioned cells CEr.

In FIG. 15, the cells CEb in the row that the numerals “0”, “1”, “1”, “2”, “3”, “1” and “1” are indicated are the cells in the lowermost row in the cells whose over ½ parts in the up/down direction are displayed on the aforementioned display screen 31a. The aforementioned numerals “0”, “1”, “1”, “2”, “3”, “1” and “1” are numerical values of the numerical value data in the row direction which has been stored for the aforementioned cells CEr.

When the right end of the aforementioned display area S reaches the position in FIG. 15, the aforementioned display control unit 322 makes the numerical value n (“1”) which is based on the numerical value data in the row direction which has been stored for the aforementioned cells CEr in FIG. 15 to be displayed on the right end of the display column C3 for the aforementioned simple images. In addition, in the row of the cells CEr that the numerical value of the numerical value data has been newly reduced to “0”, display of the aforementioned indicator In disappears.

In addition, when the right end of die aforementioned display area S reaches the position in FIG. 15 as described above, die indicator In including the numerical value n (“1”) is newly displayed on the lower end of the display column C3 for the aforementioned simple images on the basis of the numerical value data in the column direction which has been stored for the cell CErb which is in the lowermost row and has newly been in the rightmost, column in the aforementioned display area S.

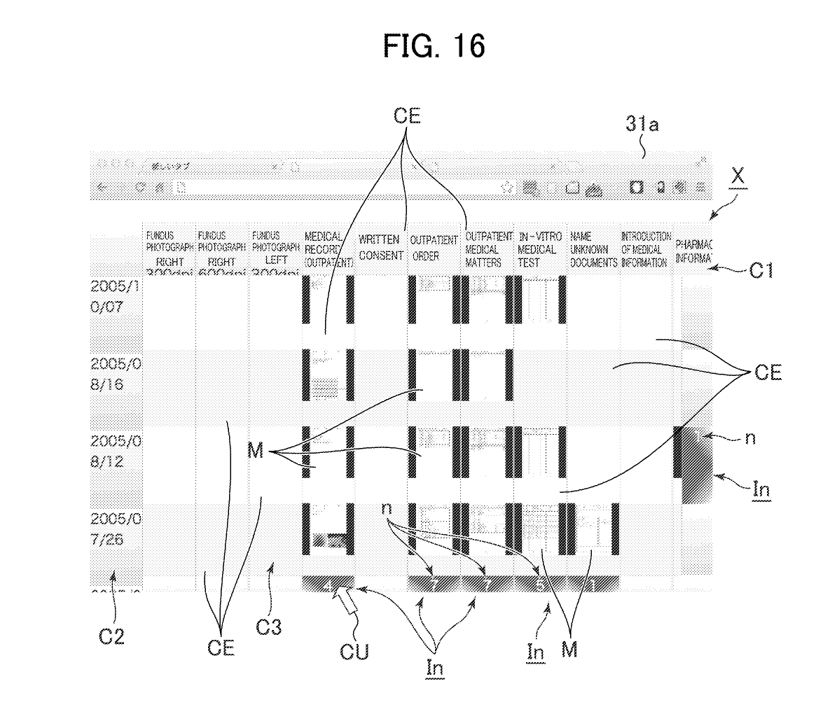

Next, a second modified example will be described. When die operator clicks the aforementioned indicator In by the cursor CU using the aforementioned input unit 33 as shown in FIG. 16, the displayed part of the list X moves such that the simple images M which are not displayed on the aforementioned display screen 31a are displayed. When die indicator In displayed on the Sower end of die display column C3 for the aforementioned simple images is clicked, the aforementioned display control unit 322 makes the displayed part of the aforementioned list X move downward. On the other hand, when the indicator In displayed on the right end of the display column C3 for the aforementioned simple images is clicked, the aforementioned display control unit 322 makes the displayed part of the list X move rightward.

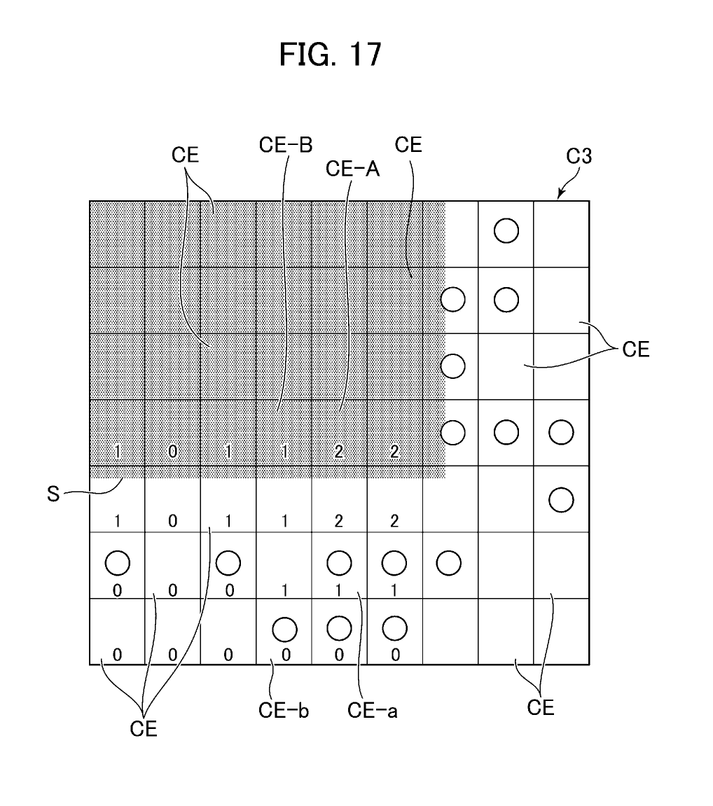

Movement of the displayed part of the list X in this example will be described in detail on the basis of FIG. 17 to FIG. 19. In FIG. 17 to FIG. 19, a list which is different from that in FIG. 16 is shown. Here, a case that the indicator In which is displayed on the lower end of the display column C3 for the aforementioned simple images has been clicked will be described by way of example. The numerals indicated in FIG. 17 to FIG. 19 indicate the numerical values of the numerical value data in the column direction which has been stored for the cells CE.

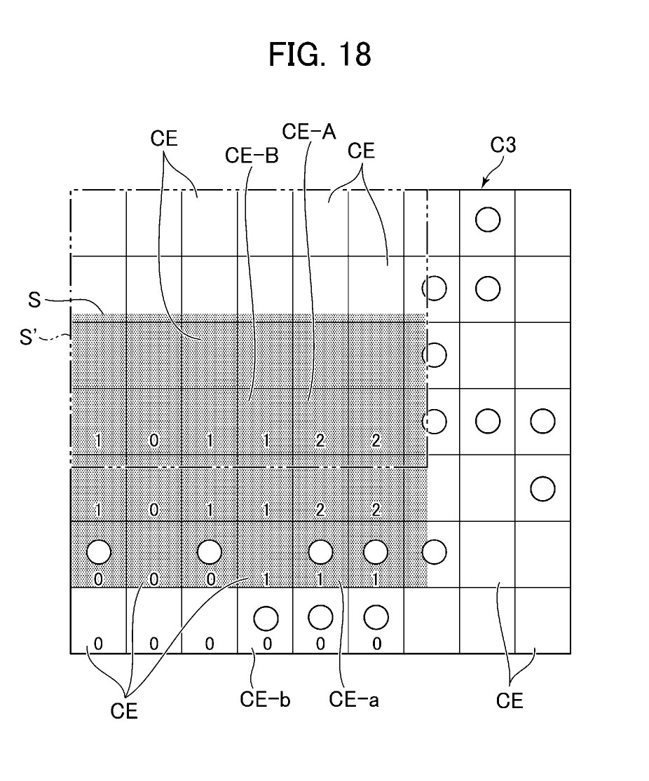

The aforementioned display control unit 322 makes the displayed part of the aforementioned list X move such that the simple image M in the cell CE that the numerical value of the aforementioned numerical value data becomes smaller than the currently displayed numerical value n is displayed in the column of foe clicked indicator In. For example, when the indicator In in the column of a cell CE-A is clicked, the aforementioned display control unit 322 makes the aforementioned display area S move such that a cell CE-a for which the numerical value data “1” which is smaller than the numerical “2” of the numerical value data which has been stored for the aforementioned cell CE-A has been stored becomes a cell in the lowermost row in the display area S as shown in FIG. 18 (the area which is surrounded with the two-dot chain line and is designated by the symbol S′ is the display area before movement).

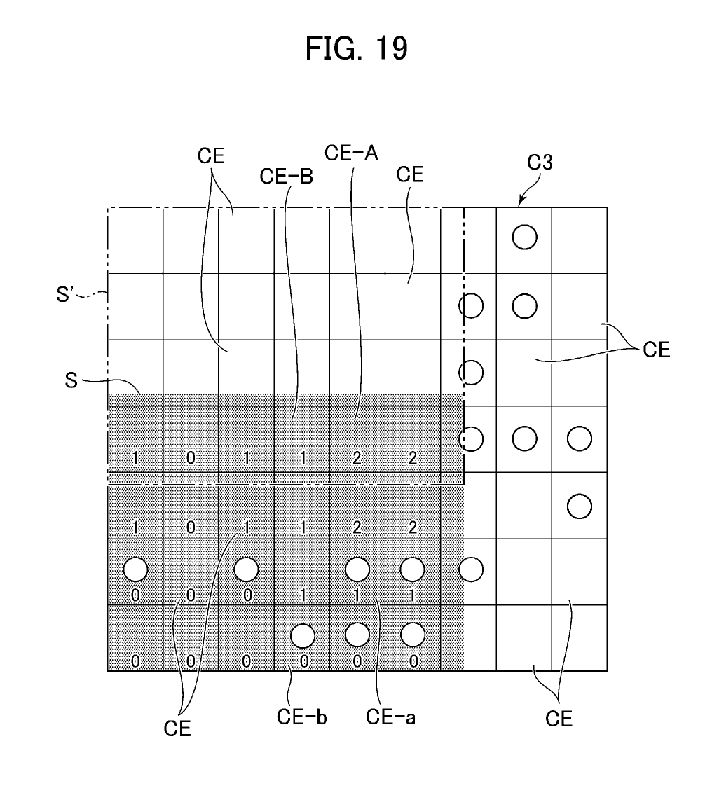

In addition, when the indicator In of a cell CE-B is clicked, for example, in the state in FIG. 17, the aforementioned display control unit 322 makes the aforementioned display area S move such that a cell CE-b for which the numerical value data “0” which is smaller than the numerical value data “1” which has been stored for the aforementioned cell CE-B has been stored becomes a cell in the lowermost row of the display area S as shown in FIG. 19.

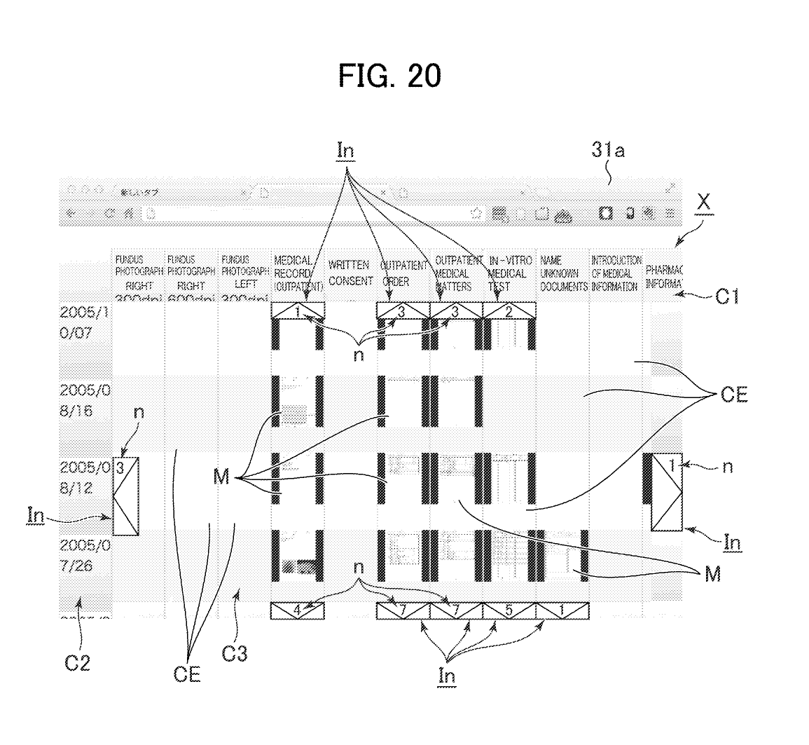

Next, a third modified example will be described. As shown in FIG. 20, the aforementioned indicators In may be displayed not only on the right end and the lower end but also on the left end and the upper end of the display column C3 for the aforementioned simple images. In this example, the aforementioned indicators In indicate presence/absence of the simple images M and their numbers not only on the lower side and the right side but also on the upper side and the left side of the displayed part of the aforementioned list X.

The numerical value n displayed on the left end of the aforementioned simple image display column C3 is displayed on the basis of the numerical value data (the numerical value data for displaying the numerical value n on the left end of the display column C3 for the aforementioned simple images) in the row direction which has been stored for the aforementioned respective cells CE. In addition, the numerical value n displayed on the upper end of the display column C3 for the aforementioned simple images is displayed on the basis of the numerical value data (the numerical value data for displaying the numerical value n on the upper end of the display column C3 for the aforementioned simple images) in the column direction which is stored for the aforementioned respective cells CE.

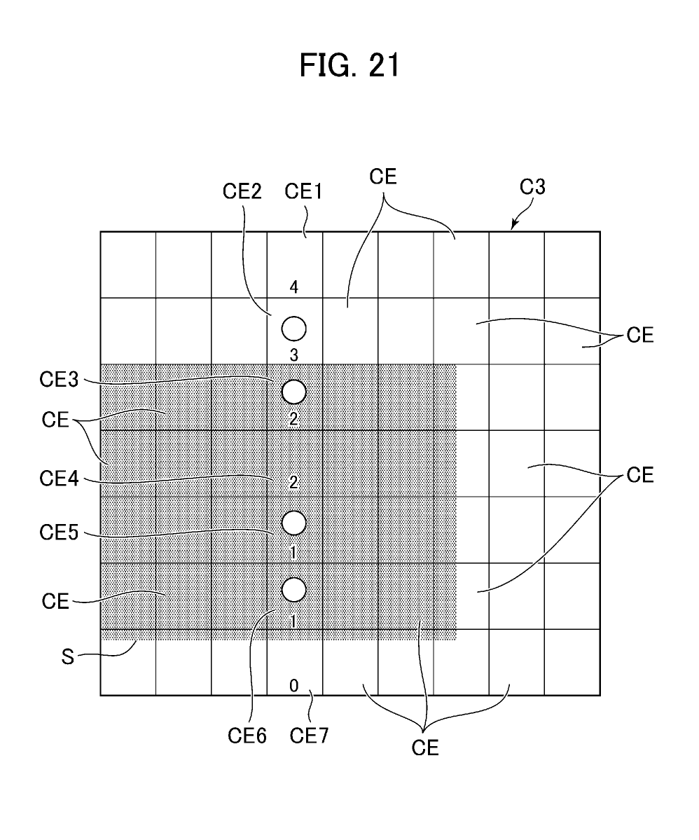

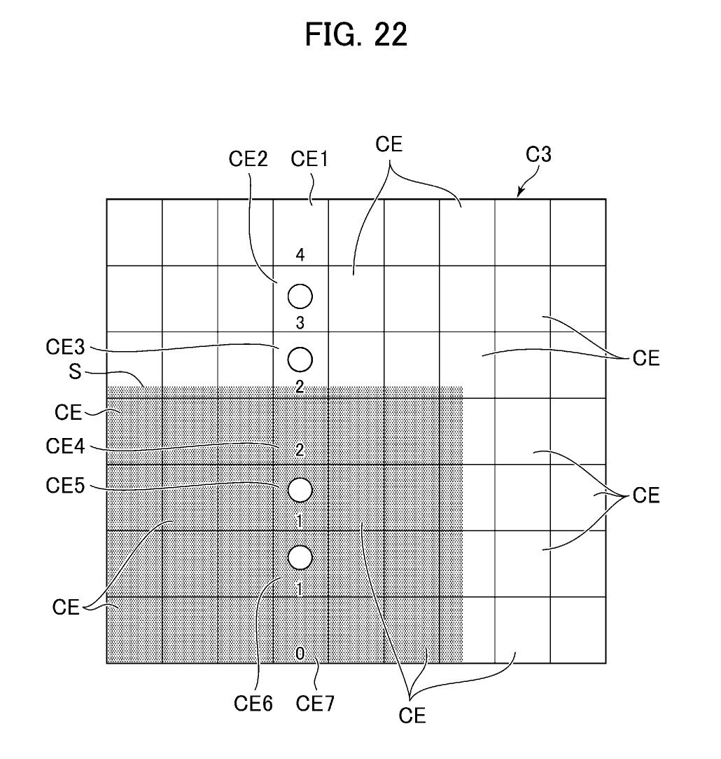

First, a method of displaying the aforementioned numerical value n on the upper end of the display column C3 for the aforementioned simple images will be described on the basis of FIG. 21 and FIG. 22. Here, in FIG. 21 and FIG. 22, a description will be made paying attention to one column (cells CE1 to CE7) that numerals are shown. The numerals shown in FIG. 21 and FIG. 22 indicate the numerical value of the numerical value data in the column direction which has been stored for the cells CE. The numerical value of this numerical value data is displayed as the numerical value n on the lower end of the display column C3 for the aforementioned simple images.

The aforementioned counting unit 23 subtracts the numerical value of the cell which is one above the cell CE in the uppermost row of the display area S from the numerical value of the cell CE in the uppermost row in the display column C3 for the aforementioned simple images to obtain the numerical value data of the numerical value n to be displayed on the upper end of the display column C3 for the aforementioned simple images. Specifically, in a case where the position of the display area S is the position shown in FIG. 21, the cell in the uppermost row of the aforementioned display area S is the cell CE3 and the cell which is one above it is the cell CE2. Therefore, the aforementioned counting unit 23 subtracts the numerical value “3” of the aforementioned cell CE2 from the numerical value “4” of the cell CE1 in the uppermost row of the display column C3 for the aforementioned simple images. Thus, the data of the numerical value “1” is obtained as the numerical value data of the numerical value n to be displayed on the upper end in the display column C3 for the aforementioned simple images. Therefore, the aforementioned display control unit 322 makes “1” to be displayed on the upper end of the display column C3 for the aforementioned simple images as the aforementioned numerical value n in the column of the aforementioned cells CE1 to CE7.

In addition, in a case where the position of the display area S is the position shown in FIG. 22, the cell in the uppermost row of the aforementioned display area S is the cell CE4 and the cell which is one above it is the cell CE3. Therefore, the aforementioned counting unit 23 subtracts the numerical value “2” of the aforementioned cell CE3 from the numerical value “4” of the cell CE1 in the uppermost row in the display column C for the aforementioned simple images. Thus, the data of the numerical value “2” is obtained as the numerical value data of the numerical value n to be displayed on the upper end of the display column C3 for the aforementioned simple images. Therefore, the aforementioned display control unit 322 makes “2” to be displayed on the upper end of the display column C3 for the aforementioned simple images as the aforementioned numerical value n in the column of the aforementioned cells CE1 to CE7.

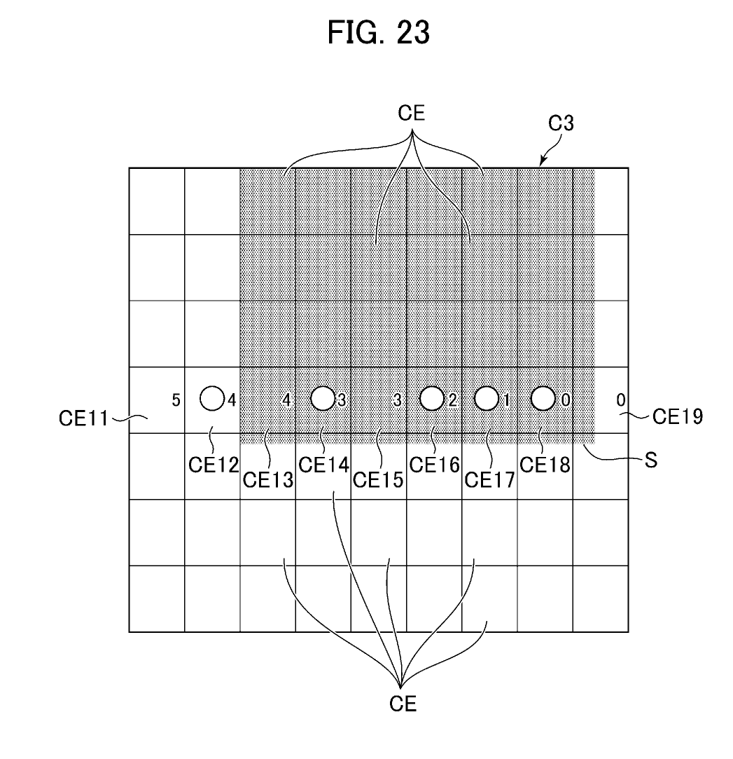

Next, a method of displaying the aforementioned numerical value n on the left end of the display column C3 for the aforementioned simple images C3 will be described on the basis of FIG. 23. Here, in FIG. 23, a description will be made paying attention to one row (cells CE11 to CE19) that numerals are shown. The numerals shown in FIG. 23 indicate the numerical value of the numerical value data in the row direction which has been stored for the cell CE. The numerical value of this numerical value data is displayed as the numerical value n on the left end of the display column C3 for the aforementioned simple images.

The aforementioned counting unit 23 subtracts the numerical value of the cell which is one on the left side of the cell CE in the leftmost column in the display area S from the numerical value of the cell CE in the leftmost column in the display column C for the aforementioned simple images to obtain the numerical value data of the numerical value n to be displayed on the left end of the display column C for the aforementioned simple images. In FIG. 23, the cell in the leftmost column in the aforementioned display area S is the cell CE13 and the cell which is one on the left side thereof is the cell CE12. Therefore, the aforementioned counting unit 23 subtracts the numerical value “4” of the aforementioned cell CE12 from the numerical value “5” of the cell CE11 in the leftmost column in the display column C3 for the aforementioned simple images. Thus, the data of the numerical value “1” is obtained as the numerical value data of the numerical value n to be displayed on the left end of the display column C for the aforementioned simple images. Therefore, the aforementioned display control unit 322 makes “1” to be displayed on the left end of the display column C for the aforementioned simple images as the aforementioned numerical value n in the row of the aforementioned cells CE11 to CE19.

Incidentally, the method of displaying the aforementioned numerical value n is not limited to the above-mentioned methods. For example, numerical value data for displaying the numerical value n on the left end and the upper end of the display column C3 for the aforementioned simple images may be stored for each cell CE, That is, in order to display the numerical value n on the left end of the display column C3 for the aforementioned simple images, in a column that a certain cell CE belongs, data of the numerical value indicating how many simple images M are present on the left side of that cell CE may be stored for each cell CE. In addition, in order to display the numerical value n on the upper end of the display column C3 for the aforementioned simple images, in a column that a certain cell CE belongs, data of the numerical value indicating how many simple images M are present above that cell CE may be stored for each cell CE.

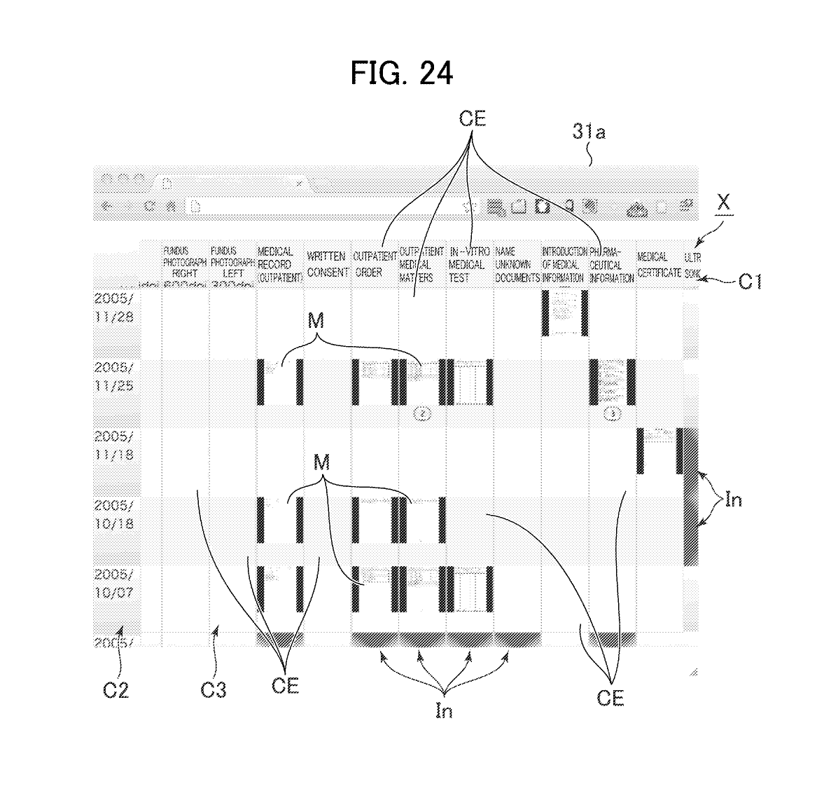

Next, a fourth modified example will be described on the basis of FIG. 24. As shown in FIG. 24, the aforementioned indicator In may not include the aforementioned numerical value n.

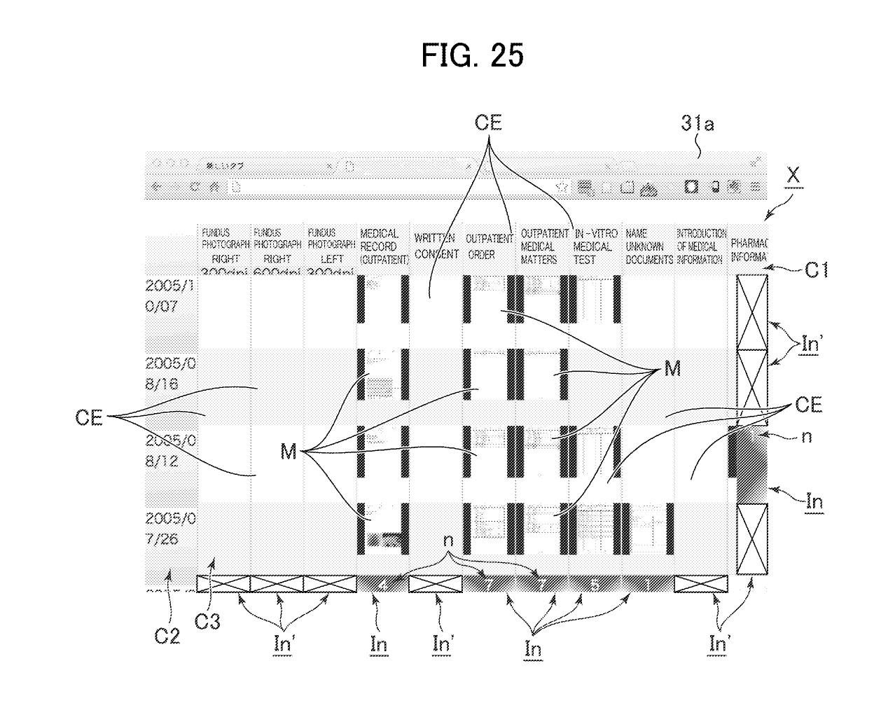

Although the present invention has been described by the aforementioned embodiments, it goes without saying that the present invention can be embodied by modifying it in a variety of ways within a range not departing from the gist thereof. For example, as shown in FIG. 25, an indicator In′ indicating that simple images which are not displayed on the aforementioned display screen 31a are not present may be displayed together with the aforementioned indicator In. In addition, though not shown in the drawing in particular, the aforementioned indicator In may not be displayed and only the aforementioned indicator In′ may be displayed.

In addition, the aforementioned list preparation unit 22 of the aforementioned server 2 may change and may not display die numerical value n of the aforementioned indicator In.

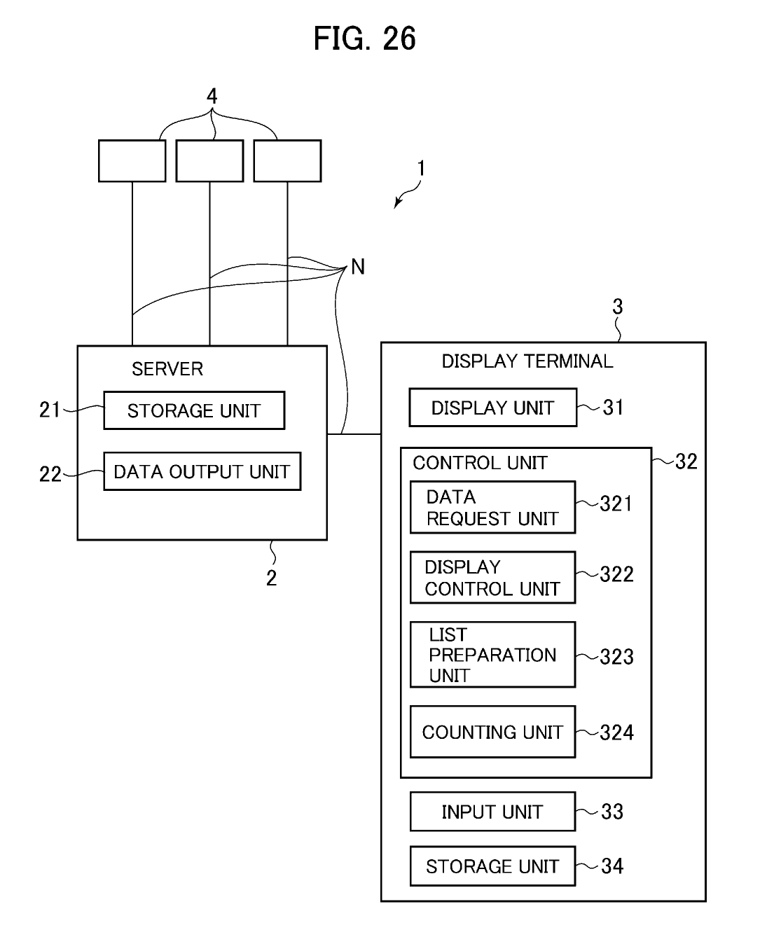

In addition, as shown in FIG. 26, the control unit 23 of die aforementioned display terminal 3 may have a list preparation unit 323 and a counting unit 324, in place of the aforementioned list preparation unit 22 and the aforementioned counting unit 23 of the aforementioned server 2.

### DESCRIPTION OF REFERENCE NUMERALS OR SYMBOLS

1 image display system
2 server
3 display terminal (display device)
21 storage unit
23, 324 counting unit
31 display unit
33 input unit
322 display control unit
X list
M simple image

What is claimed is:

1. A display device, comprising;
a display unit configured to partially display a list of images based on medical data in a display area, wherein the images are arranged in a matrix,
wherein the display unit comprises an indicator for indicating a presence and/or an absence of images which are not displayed on the display unit in the list of images and indicating the presence and/or the absence of the images which are not displayed on the display unit on at least one of the upper side, the lower side, the right side, and the left side of the display area.

2. The display device as defined in claim 1, wherein the indicator comprises the number of images which are not displayed on the display unit.

3. The display device as defined in claim 1, wherein the list of images is a list of images which are based on medical data having incidental information on a plurality of attributes as metadata, and images of the same patient are arranged in a row direction for every incidental information of one attribute and in a column direction for every incidental information of another attribute.

4. The display device as defined in claim 1, wherein the indicator is displayed per row and/or per column on the display area.

5. The display device as defined in claim 4, wherein the indicator comprises a numerical value indicating the number of images which are not displayed on the display unit in each row and/or each column of the list.

6. The display device as defined in claim 5, further comprising a counting unit for counting images in the column direction and/or the row direction of the list to obtain the numerical value data for displaying the numerical value in the indicator.

7. The display device as defined in claim 6, wherein the counting unit obtains the numerical value data per cell that the image is arranged on the list.

8. The display device as defined in claim 7, wherein the counting unit performs at least one of counting of images which are present on the left side of each cell and counting of images which are present on the right side of each cell with regard to each cell in each row of the list to obtain the numerical value data in the row direction of the each cell.

9. The display device as defined in claim 7, wherein the counting unit performs at least one of counting of images which are present above each cell and counting of images which are present under each cell with regard to each cell in each column of the list to obtain the numerical value data in the column direction of the each cell.

10. The display device as defined in claim 3, wherein the list comprises a display column for the incidental information and a display column for images, and the indicator is displayed on an end of each row and/or each column on the display column for the images.

11. The display device as defined in claim 1, further comprising:
an input unit for an operator to perform an inputting operation; and
a display control unit for making images which are not displayed on the display unit display within the list when the inputting operation for designating the indicator is performed by the input unit.

12. The display device as defined in claim 1, further comprising:
an input unit for the operator to perform an inputting operation, wherein the display control unit makes the displayed part of the list move in a direction according to the inputting operation by the input unit.

13. An image display system having a server connected with the display device defined in claim 1, wherein the server comprises a storage unit for storing the medical data.

14. The image display system as defined in claim 13, wherein the server further comprises a counting unit for counting images in the column direction and/or the row direction of the list to obtain the numerical value data for displaying a numerical value indicating the number of images which are not displayed on the display unit in each row and/or each column of the list as a part of the indicator.

15. The image display system as defined in claim 14, wherein the counting unit obtains the numerical value data per cell in which the image is arranged.

16. The image display system as defined in claim 15, wherein the counting unit performs at least one of counting of images which are present on the left side of each cell and counting of images which are present on the right side of each cell with regard to each cell in each row of the list to obtain the numerical value data in the row direction of the each cell.

17. The image display system as defined in claim 15, wherein the counting unit performs at least one of counting of images which are present above each cell and counting of images which are present under each cell with regard to each cell in each column of the list to obtain the numerical value data in the column direction of the each cell.

18. A method for displaying images, the method comprising:
a list preparation function of preparing a list of images are based on medical data, wherein the images are arranged in a matrix;
partially displaying the list of images; and
a display control function of making an indicator indicating presence and or absence of images which are not displayed on a display unit that the list is displayed, and indicating presence and/or absence of the images on at least one of the upper side, the lower side, the right side and the left side of a displayed part of the list in images configuring the list which has been prepared by the list preparation function to be displayed on the display unit.

19. The display device as defined in claim 2, wherein the list of images is a list of images which are based on medical data having incidental information on a plurality of attributes as metadata, and images of the same patient are arranged in a row direction for every incidental information of one attribute and in a column direction for every incidental information of another attribute.

20. The display device as defined in claim 19, wherein the indicator is displayed per row and/or per column on the display area.
